(19) United States
(12) Patent Application Publication
(10) Pub. No.: US 2025/0119008 A1
(43) Pub. Date: Apr. 10, 2025

(54) PRINTED CIRCUIT BOARD AXIAL FLUX MACHINE FOR STEER-BY-WIRE HANDWHEEL ACTUATOR

(71) Applicant: Steering Solutions IP Holding Corporation, Saginaw, MI (US)

(72) Inventors: Anik Chowdhury, Auburn Hills, MI (US); Alejandro Pina Ortega, Grand Blanc, MI (US); Rong Yang, Troy, MI (US); Shuvajit Das, Sterling Heights, MI (US)

(21) Appl. No.: 18/482,548

(22) Filed: Oct. 6, 2023

(51) Int. Cl. H02K 1/27; B62D 5/00; H02K 1/12; H02K 7/00

(52) U.S. Cl. CPC H02K 1/27; B62D 5/006; H02K 1/12; H02K 7/003

(57) ABSTRACT

An axial flux machine (AFM) includes: a rotor assembly configured to rotate about an axis. The rotor assembly includes a first rotor core and second rotor core. Each of the first rotor core and the second rotor core have a plurality of permanent magnets attached thereto, and each of the first rotor core and the second rotor core are spaced apart and parallel to one another and perpendicular to the axis. The AFM also includes a stator assembly having a PCB located between the first rotor core and the second rotor core and parallel thereto. The PCB defines a stator winding configured to generate a magnetic flux in an axial direction through each of the first rotor core and the second rotor core to cause the AFM to generate a torque. A steer-by-wire system includes a handwheel actuator including the AFM coupled to apply a torque to a steering wheel.

### TECHNICAL FIELD

This disclosure relates to axial flux electric machines with printed circuit board (PCB) windings, and applications of such axial flux electric machines in a handwheel actuator of a steering system for a vehicle.

### BACKGROUND

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

Steer by wire (SbW) is a direct evolution of the electric power steering (EPS) system where there is no mechanical coupling between the handwheel and the steering rack. An EPS system may include a single actuator with the sole purpose of providing assist to the driver during steering actions. However, on the SbW system, there may be two electric actuators/motors with different functionalities. The electric actuator attached to the rack in a SbW system is called the roadwheel actuator (RWA), whereas the actuator on the driver side is known as the handwheel actuator (HWA). The RWA has the same assist providing function as an EPS system actuator. The HWA on the other hand acts more as a feedback motor rather than providing assist to the driver. In the absence of the HWA the handwheel on a SbW system would just freewheel because of the absence of any mechanical coupling/friction. The HWA, because of its' functionality opens a wide array of design related opportunities.

Based on their functionality, the torque speed curves of the different actuators used in steering systems may also be different. The very different operating domains of the EPS/RWA and the HWA motivates design exploration for HWA technology.

### SUMMARY

This disclosure relates generally to axial flux electric machines.

An aspect of the disclosed embodiments includes an axial flux machine (AFM). The AFM includes: a rotor assembly configured to rotate about an axis. The rotor assembly includes a first rotor core and second rotor core, with each of the first rotor core and the second rotor core having a plurality of permanent magnets attached thereto, and with each of the first rotor core and the second rotor core spaced apart and parallel to one another and perpendicular to the axis. The AFM also includes a stator assembly. The stator assembly includes at least one PCB located between the first rotor core and the second rotor core and parallel thereto. The at least one PCB defines a stator winding configured to generate a magnetic flux in an axial direction through each of the first rotor core and the second rotor core to cause the AFM to generate a torque.

An aspect of the disclosed embodiments includes a steer-by-wire system for a vehicle. The steer-by-wire system includes a handwheel actuator coupled to apply a torque to a steering wheel. The handwheel actuator includes an axial flux machine (AFM). The AFM includes a rotor assembly configured to rotate about an axis. The rotor assembly includes a first rotor core and second rotor core, with each of the first rotor core and the second rotor core having a plurality of permanent magnets attached thereto, and with each of the first rotor core and the second rotor core spaced apart and parallel to one another and perpendicular to the axis. The AFM also includes a stator assembly. The stator assembly includes at least one PCB located between the first rotor core and the second rotor core and parallel thereto. The at least one PCB defines a stator winding configured to generate a magnetic flux in an axial direction through each of the first rotor core and the second rotor core to cause the AFM to generate a torque.

These and other aspects of the present disclosure are disclosed in the following detailed description of the embodiments, the appended claims, and the accompanying figures

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an electric power steering (EPS) system according to the principles of the present disclosure.

FIG. 2 generally illustrates an electric power steering (EPS) system according to the principles of the present disclosure.

FIG. 3 generally illustrates a steer-by-wire (SbW) steering system according to the principles of the present disclosure.

FIG. 4 is a schematic diagram of a motor drive system according to the principles of the present disclosure.

FIG. 5 shows a graph illustrating torque-speed curves of steering system actuators according to the principles of the present disclosure.

FIG. 6 shows a cross-sectional diagram of a radial flux machine (RFM) according to the principles of the present disclosure.

FIG. 7 shows a cross-sectional diagram of an axial flux machine (AFM) according to the principles of the present disclosure.

FIG. 8 shows a sectional view of a first AFM assembly with a slotted stator core.

FIG. 9 shows a sectional view of a second AFM assembly with a stator core with slotless stator core according to the principles of the present disclosure.

FIG. 10 shows a sectional view of a third AFM assembly according to the principles of the present disclosure, with two rotor cores extending parallel and spaced apart from one another and with a stator assembly including two PCBs in a parallel arrangement and located between the two rotor cores.

FIG. 11 shows a sectional view of an AFM device according to the principles of the present disclosure, with sets of two rotor cores each extending parallel and spaced apart from one another and with a stator assembly including two sets of PCBs each in a parallel arrangement and located between a corresponding set of the two rotor cores.

FIG. 12 shows a sectional view of a fourth AFM assembly, including a passive damping PCB, according to the principles of the present disclosure.

FIG. 13 shows a sectional view of a fifth AFM assembly, with short-circuited windings within or between the two PCBs.

FIG. 14 shows a schematic diagram of stator windings within an AFM, according to the principles of the present disclosure.

FIG. 15 shows a graph indicating braking torque as a function of speed for an AFM with short circuited windings having different numbers of turns, according to the principles of the present disclosure.

FIG. 16 shows a graph indicating short circuit current as a function of speed for an AFM with short circuited windings having different numbers of turns, according to the principles of the present disclosure.

FIG. 17 shows a schematic diagram of stator windings within an AFM with switched braking, according to the principles of the present disclosure.

FIG. 18 shows a graph indicating braking torque as a function of speed for an AFM with short circuited windings different resistances, according to the principles of the present disclosure.

FIG. 19 shows a graph indicating short circuit current as a function of speed for an AFM with short circuited windings different resistances, according to the principles of the present disclosure.

FIG. 20 shows a graph of torque over time, including plots representing braking torque, torque produced by active windings, and total torque, of an AFM with passive braking, according to the principles of the present disclosure.

FIG. 21 shows a PCB assembly with a partial cut-away to show various winding configurations, according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an EPS system, an SbW steering system, a hydraulic steering system, or other suitable steering system. The steering system of such a vehicle typically controls various aspects of vehicle steering including providing steering assist to an operator of the vehicle, controlling steerable wheels of the vehicle, and the like.

The present disclosure provides an axial flux machine (AFM), which may be particularly well suited for geared structure and for high speed operation. The AFM may include a modular, spatially shifted three-phase or multiphase stator structure. The AFM may include printed circuit board (PCB) structure and slotless stator topology. The AFM may structure with single or multiple rotor stacks with high volumetric and gravimetric torque density. The AFM may be relatively easily and efficiently manufacture and may provide suitable performance for a variety of applications in an EPS and/or SbW system.

The present disclosure provides an AFM structure to provide damping during the power off and faulty condition of the motor. The layers of the PCBs can be shortened to achieve the damping or a separate PCB can be introduced to achieve the damping of the motor. Moreover, the number of turns, trace width of the coil in the shortened PCB can be entirely different than the active PCB of the machine. Added resistance can be used with the shortened PCB to control the short circuit current and the braking torque of the machine. These additional resistance can be directly implemented in the PCB to reduce manufacturing difficulties and the overall cost of the machine. Moreover, additional circuitry along with the gate drives and switches can be implemented in the PCB to control connections of the coil depending on the speed of the operation. These additional circuitry can also be implemented in the same PCB to reduce the cost and manufacturing difficulties of the machine.

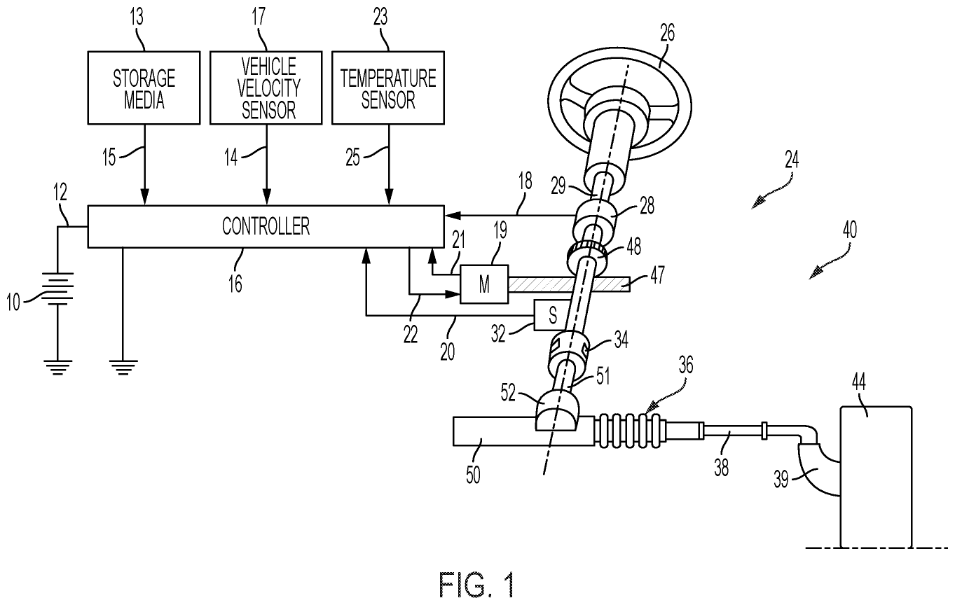

FIG. 1 is a schematic diagram of an electric power steering system (EPS) 40 suitable for implementation of the disclosed techniques. The EPS includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system generally designated by reference numeral 24 and includes the controller 16 and an electric machine, which could be a permanent magnet synchronous motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time-based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 16 may include input signal processing and filtering to enable accurate sampling and conversion or acquisitions of such signals from communications interfaces.

As used herein, variables with a tilde (˜) above the variable symbol represent an approximation, which may be determined by a mathematical calculation, a lookup table, etc. Variables with a bar above the variable symbol represent a vector quantity. Variables with a superscript star (*) represent commands or desired set point values.

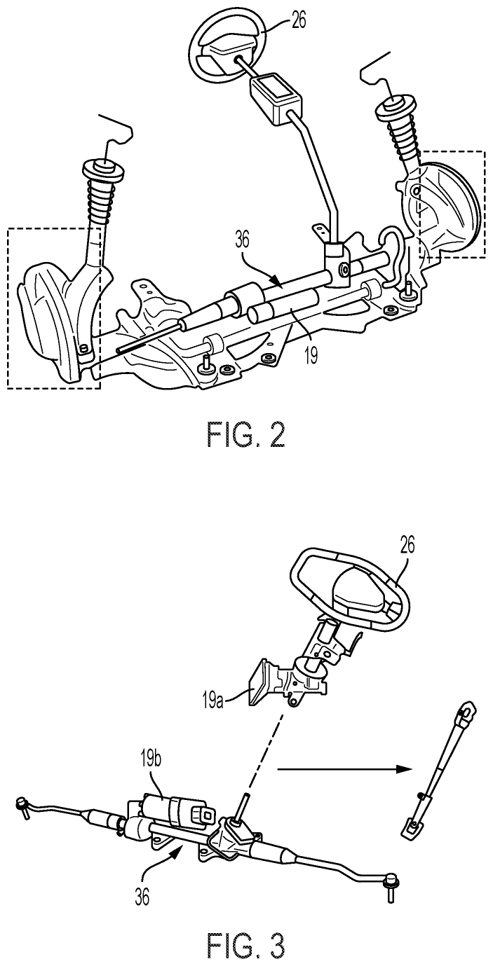

FIG. 2 generally illustrates an electric power steering (EPS) system, and FIG. 3 generally illustrates a steer-by-wire (SbW) steering system. The EPS system of FIG. 2 may be similar or identical to the EPS system 40 of FIG. 1, except with the motor 19 mounted directly to the steering mechanism 36. The SbW system of FIG. 2 may be similar or identical to the EPS system 40 of FIG. 1, except without any physical linkage between the steering wheel 26 and the steerable wheels 44, and with two separate and independent motors 19a, 19b. As shown, the SbW system includes a first motor 19a, also called a handwheel actuator (HWA), configured to provide a torque to the steering wheel 26 for providing haptic feedback to a driver.

Steer by wire (SbW) is a direct evolution of the electric power steering (EPS) system where there is no mechanical coupling between the steering wheel 26 and the steering rack. As seen in FIG. 2, an EPS system may include a single actuator 19 with the sole purpose of providing assist to the driver during steering actions. However, on the SbW system, there are two electric actuators/motors with different functionalities. The electric actuator on the driver side is known as the handwheel actuator (HWA) 19a, whereas the electric actuator attached to the steering mechanism 36 in a SbW system is called the roadwheel actuator (RWA) 19b. The RWA 19b may provide the same assist function as the actuator 19 in an EPS system. The HWA 19a, on the other hand, acts more as a feedback motor rather than providing assist to the driver. In the absence of the HWA 19a the handwheel on a SbW system would just freewheel because of the absence of any mechanical coupling/friction.

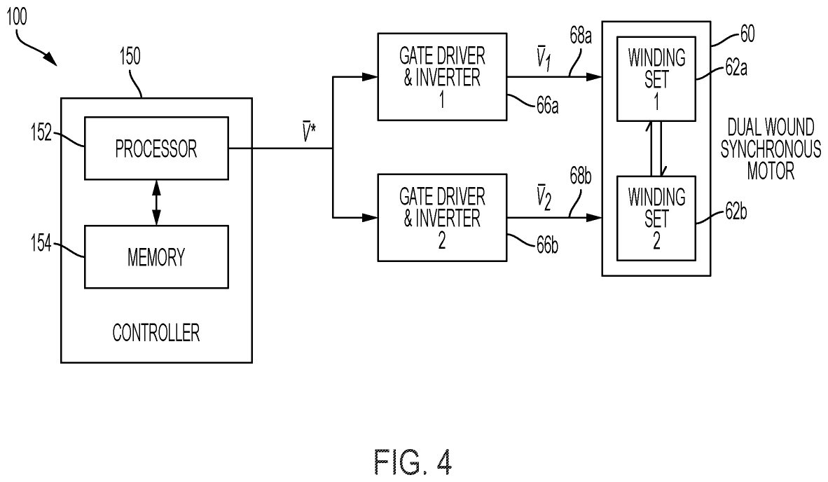

FIG. 4 shows a motor control system 100 having a dual wound permanent magnet synchronous motor (DW-PMSM), also called a dual wound synchronous machine (DWSM) or a dual wound motor 60, power converters 66a and 66b (each including a gate driver and a corresponding inverter), and a motor controller 70 (also referred to as a controller). The dual wound motor 60 may be used in any number of applications, such as for the motor 19 in the steering motion control system 24 shown in FIG. 1 or for either of the HWA 19a or the RWA 19b. The power converters 66a and 66b may include several switching devices, such as field effect transistors (FETs) for switching high current loads and gate driver circuitry for operating the switching devices.

The dual wound motor 60 includes a first winding set 62a and a second winding set 62b that is electrically independent of the first winding set 62a. The dual wound motor 60 is capable of generating electromagnetic torque by energizing either or both winding sets 62a, 62b. The two winding sets 62a and 62b may each include three phases and thus, each of the two winding sets 62a, 62b may include three phase windings. Alternatively, each of the winding sets 62a, 62b may include any number of winding phases, such as five or seven phases. In some embodiments, the dual wound motor 60 is a poly-phase permanent magnet synchronous machine (PMSM). Each of the winding sets 62a, 62b may function individually, and the dual wound motor 60 can be operated by energizing either or both of the winding sets 62a, 62b.

The motor control system 100 includes a controller 150. The controller 150 may include any suitable controller. The controller 150 may be configured to control, for example, the various functions of the vehicle systems described herein. The controller 150 may include a processor 152 and a memory 154. The processor 152 may include any suitable processor, such as those described herein. Additionally, or alternatively, the controller 150 may include any suitable number of processors, in addition to or other than the processor 152. The memory 154 may comprise a single disk or a plurality of disks (e.g., hard drives), and includes a storage management module that manages one or more partitions within the memory 154. In some embodiments, memory 154 may include flash memory, semiconductor (solid state) memory or the like. The memory 154 may include Random Access Memory (RAM), a Read-Only Memory (ROM), or a combination thereof. The memory 154 may include instructions that, when executed by the processor 152, cause the processor 152 to, at least, control various functions of the steering system and/or any other suitable function, including those of the systems and methods described herein.

The controller 150 may receive one or more signals from various measurement devices or sensors indicating sensed or measured characteristics of the vehicle. The sensors may include any suitable sensors, measurement devices, and/or other suitable mechanisms. For example, the sensors may include one or more torque sensors or devices, one or more handwheel position sensors or devices, one or more motor position sensor or devices, one or more motor angle sensors or devices, other suitable sensors or devices, or a combination thereof. The one or more signals may indicate a handwheel torque, a handwheel angle, a motor angle or motor positon, a vehicle speed, other suitable information, or a combination thereof.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

The controller 150 may generate a voltage command V̅* based on a motor torque command Tₑ* or by other means, and supply the voltage command V̅* to each of the power converters 66a and 66b. For example, controller 150 may include a voltage command generator (not shown) to generate the voltage command V̅* using one or more optimizations and/or to cause the electric motor drive system to satisfy one or more operating constraints, such as constraints on voltage and/or current produced by or supplied to the electric motor drive system. The feedforward voltage control technique may include a technique provided in the present disclosure, although other feedforward control techniques may be used.

The power converters 66a and 66b are configured to supply alternating current (AC) voltages to the winding sets 62a and 62b, respectively. The winding sets 62a, 62b are connected to their respective power converters 66a, 66b through the phase leads 68a and 68b. This configuration may provide for redundancy, allowing the dual wound motor 60 to continue to function even with a total loss or failure of one of the winding sets 62a, 62b, one of the motor leads 68a, 68b, and/or one of the power converters 66a, 66b. The power converters 66a, 66b may be implemented with electrical isolation for additional redundancy.

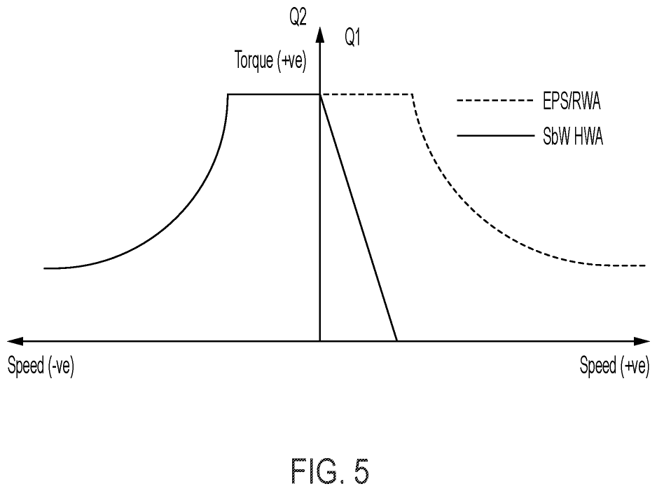

FIG. 5 shows a graph illustrating torque-speed curves of steering system actuators 19, 19a, and 19b. Based on their functionality, the different steering system actuators 19, 19a, 19b have different speed curves. As indicated by the dashed line in FIG. 5, the EPS actuator 19 and the RWA 19b in a SbW each work in the first quadrant (Q1) of the torque-speed curve. The positive direction of speed in Q1 suggests that the actuator acts in the same direction as the driver's handwheel motion and provides assist. However, as indicated by the solid line, the HWA 19a of the SbW system operates mostly in the second quadrant (Q2) of the torque-speed curve. The HWA 19a moves opposite (speed-ve) to the driver's handwheel motion and provides feedback to the driver. This feedback may be necessary to provide generic steering feel and road condition feedback to the driver. Additionally, some low-speed assist (Q1 operation) might also be required from the HWA 19a, as seen in FIG. 5.

The HWA 19a may include an electric motor coupled apply torque to the steering wheel 26 configurations, such as a Worm gear drive, Belt drive, and/or a Direct drive. For the worm gear and belt driven cases, low torque of about 3 Newton meters (Nm) and high speed of about 3000 revolutions per minute (RPM). PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems.

Based on their functionality, the torque speed curves of the different actuators used in steering systems also changes. As shown in FIG. 5, the EPS actuator and the RWA in a SbW system, each work in the first quadrant (Q1) of the torque-speed curve. The positive direction of speed in Q1 suggests that the actuator acts in the same direction as the driver's handwheel motion and provides assist. However, the SbW HWA operates mostly in the second quadrant (Q2) of the torque speed curve. The HWA moves opposite (speed-ve) to the driver's handwheel motion and provides feedback to the driver. This feedback is necessary to provide generic steering feel and road condition feedback to the driver. Moreover, some low-speed assist (Q1 operation) might also be required from the HWA, as seen in FIG. 5. The very different operating domains of the EPS/RWA and the HWA motivates design exploration for HWA technology.

The HWA may include an electric motor coupled apply torque to the steering wheel 26 configurations, such as a Worm gear drive, Belt drive, and/or a Direct drive. For the worm gear and belt driven cases, low torque (˜3 Nm) and high speed (˜3000 RPM) PMSMs can be used as the actuator. Both surface mounted PMSM (SPMSM) and interior PMSM (IPMSM) topologies can be used for such HWA architectures. Moreover, because of their similarity (in terms of torque speed ranges) a significant number of components can be transferred directly from column EPS (CEPS) systems to worm gear or belt driven SbW handwheel systems.

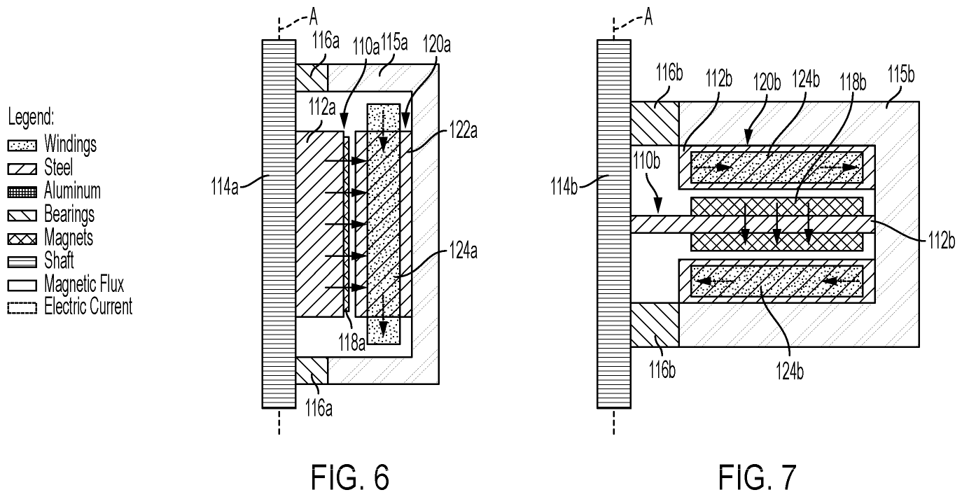

FIG. 6 shows a cross-sectional diagram of a radial flux machine (RFM). FIG. 7 shows a cross-sectional diagram of an axial flux machine (AFM). Each of the RFM and AFM devices includes a shaft configured to rotate about an axis A. Classification between the RFM and the AFM configurations may be made based on direction of magnetic flux.

The RFM of FIG. 6 includes a first rotor assembly 110a having a first rotor core 112a attached to rotate with a first shaft 114a about an axis A. The rotor assembly 110a is located within a first housing 115a and the first shaft 114a extends through and out of the first housing 115a and is supported by a pair of first bearings 116a. A set of first permanent magnets 118a is attached to the first rotor core 112a and produces a magnetic flux that extends radially outwardly. The RFM of FIG. 7 also includes a first stator assembly 120a having a first stator core 122a with a set of first windings 124a extending therethrough and carrying electric current in an axial direction, parallel to the axis A, and perpendicular to the magnetic flux.

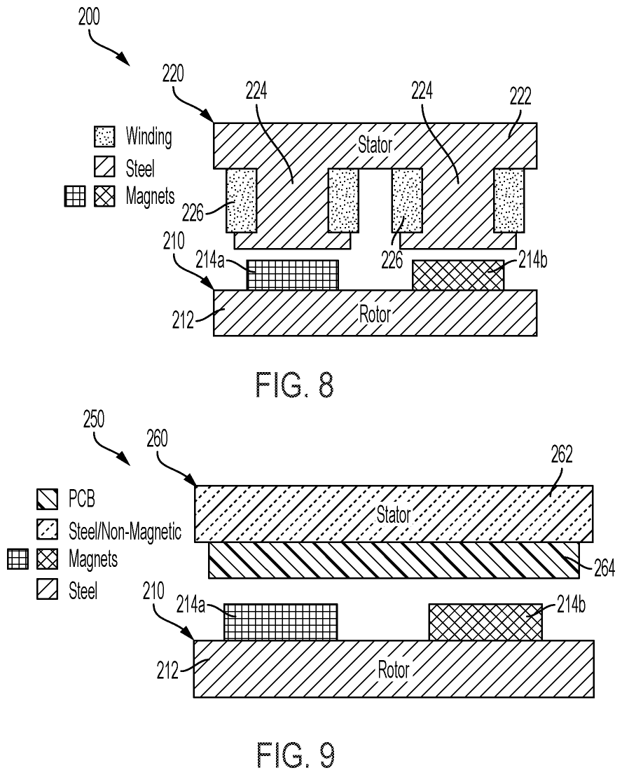

The AFM of FIG. 7 includes a second rotor assembly 110b having a second rotor core 112b attached to rotate with a second shaft 114b about an axis A. The second rotor assembly 110b is located within a second housing 115b and the second shaft 114b extends through and out of the second housing 115b and is supported by a pair of second bearings 116b. A set of second permanent magnets 118b is attached to the second rotor core 112b and produces a magnetic flux that extends in an axial direction, parallel to the axis A. The AFM of FIG. 8 also includes a second stator assembly 120b having a second stator core 122b with a set of second windings 124b extending therethrough and carrying electric current in a radial direction, perpendicular to the axis A, and perpendicular to the magnetic flux.

As shown in FIG. 6, the magnetic flux in the RFM extends primarily in a radial direction, perpendicularly to the axis A. As shown in FIG. 7, the magnetic flux in the AFM extends primarily in an axial direction, parallel to the axis A. The RFM and AFM configurations may each provide different volumetric and gravimetric power densities.

The present disclosure provides an axial flux machine (AFM) topology for a gear driven SbW HWA architecture. Axial flux machines have the potential to provide significant power density advantages over the traditional radial flux machines in the high speed, low torque region of operation of a gear driven SbW HWA.

FIG. 8 shows a sectional view of a first AFM assembly 200 with a slotted stator core. The first AFM assembly 200 includes a rotor assembly 210 and a first stator assembly 220 having a first stator core 222. The rotor assembly 210 is attached to a motor shaft and configured to rotate about an axis (not shown in the Figures), while the first stator assembly 220 remains stationary. The rotor assembly 210 includes a rotor core 212 that extends in a flat plane, perpendicular to the axis of rotation. The rotor assembly 210 includes two permanent magnets 214a, 214b disposed on a surface of the first rotor core 212, facing toward the first stator assembly 220. The first stator core 222 defines two teeth 224 that each have an I-shaped cross section, extending toward a corresponding one of the two permanent magnets 214a, 214b. The first stator assembly 220 also includes a first winding 226 disposed about each of the two teeth 224 of the first stator core 222.

FIG. 9 shows a sectional view of a second AFM assembly 250, according to the principles of the present disclosure. The second AFM assembly 250 includes a rotor assembly 210 that is similar or identical to the rotor assembly 210 of the first AFM assembly 200. The second AFM assembly 250 also includes a second stator assembly 260 which may be called a slotless stator because it does not include the teeth 224 or corresponding slots therebetween. Instead, the second stator assembly 260 includes a second stator core 262 and a printed circuit board (PCB) 264 attached thereto and extending parallel to and spaced apart from the rotor core 212.

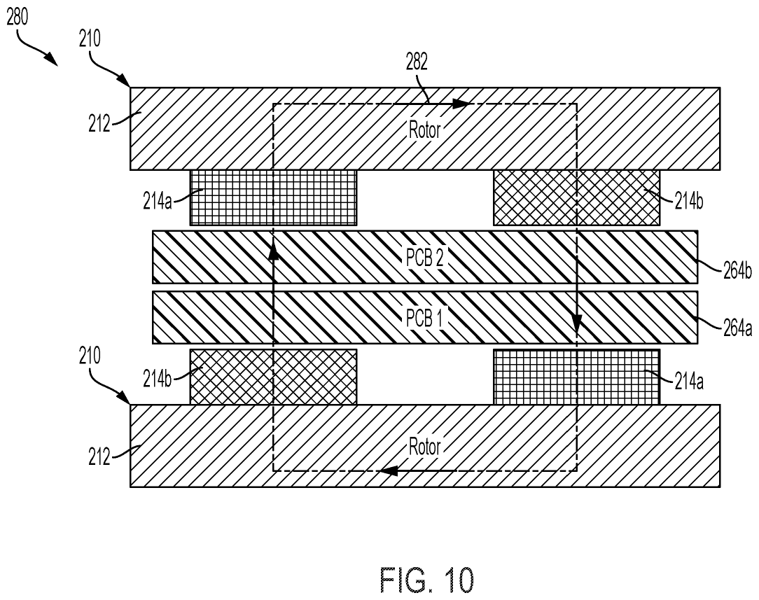

FIG. 10 shows a sectional view of a third AFM assembly 280, according to the principles of the present disclosure. The third AFM assembly 280 includes a dual PCB, dual rotor design, without any stator core of magnetic material, such as steel. The third AFM assembly 280 includes two rotor assemblies 210, each of which may be similar or identical to the rotor assembly 210 of the first AFM assembly 200. The two rotor assemblies 210 each have a rotor core 212, with the two rotor cores spaced apart and parallel to one another and perpendicular to the axis of rotation (not shown on the FIG.). Each of the two rotor assemblies 210 also includes plurality of permanent magnets 214a, 214b disposed on a surface of the corresponding rotor core 212 and facing toward the other one of the two rotor assemblies 210.

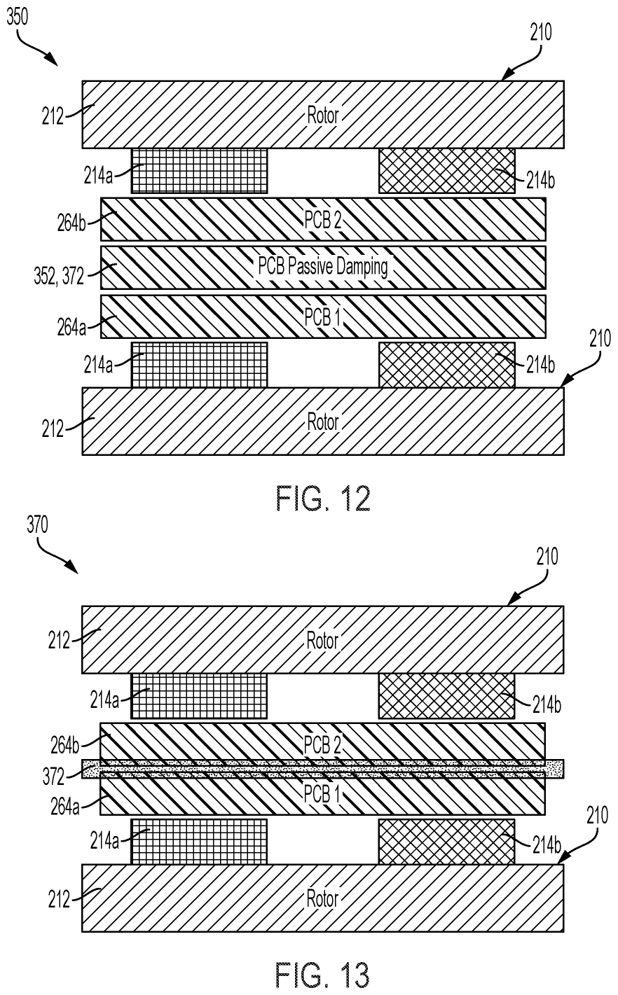

The third AFM assembly 280 also includes a first active PCB 264a and a second active PCB 264b adjacent to one another and each located between the two rotor cores 212 and parallel thereto. Each of the first active PCB 264a and the second active PCB 264b defines a stator winding (not shown in FIG. 12) configured to generate a magnetic flux in an axial direction through each of two rotor cores 212 to cause the third AFM assembly 280 to generate a torque. As shown, the magnetic flux defines a closed loop path 282.

In some embodiments, the third AFM assembly 280 may be configured as a dual-wound device. For example, the first active PCB 264a may define the first winding set 62a, and the second active PCB 264b may define the second winding set 62b.

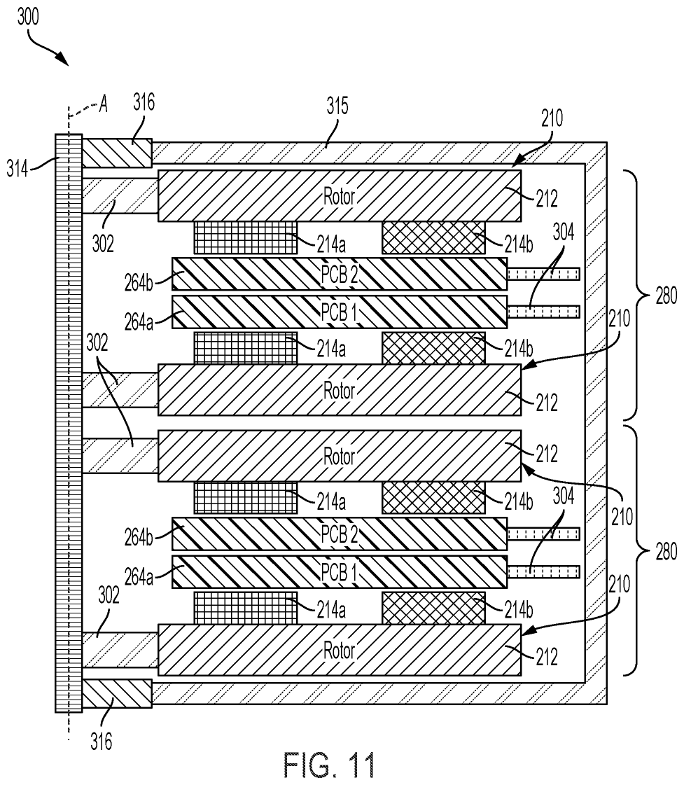

FIG. 11 shows a sectional view of an AFM device 300, according to the principles of the present disclosure. The AFM device 300 may also be called an AFM. The AFM device 300 includes a double stage structure, with two of the third AFM assemblies 280 each coupled to a motor shaft 314 to rotate about an axis A. Each of the third AFM assemblies 280 in the AFM device 300 may also be called AFM stages. It should be appreciated that this is merely an example, and an AFM may be constructed with a different number of the AFM assemblies 280.

The AFM device 300 includes a housing 315 that extends around the motor shaft 314, with bearings 316 supporting the motor shaft 314 to enable the motor shaft 314 to rotate about the axis. The AFM device 300 includes four rotor assemblies 210, each of which may be similar or identical to the rotor assembly 210 of the first AFM assembly 200, and each including a rotor core 212 that is attached to the motor shaft 314 by a rotor support 302. Each of the rotor cores 212 are spaced apart and parallel to one another and perpendicular to the axis A. The AFM device 300 also includes two sets of two active PCBs 264a, 264b, with each set of the active PCBs 264a, 264b disposed between two corresponding ones of the rotor cores 212 and parallel thereto. Each of the active PCBs 264a, 264b may held in stationary position by PCB supports 304 that attach to the housing 315.

FIG. 12 shows a sectional view of a fourth AFM assembly 350, according to the principles of the present disclosure. The fourth AFM assembly 350 may be similar or identical to the third AFM assembly 280, with the addition of a passive damping PCB 352 between the first active PCB 264a and the second active PCB 264b. The passive damping PCB 352 defines one or more passive damping windings 372, each having a short circuited configuration to produce a braking torque. In some embodiments, the passive damping windings 372 of the passive damping PCB 352 may be permanently connected in the short circuited configuration, thereby causing the passive damping PCB 352 to produce a constant braking torque at all times. Alternatively or additionally, some or all of the passive damping windings 372 of the passive damping PCB 352 may be selectively connected in the short circuited configuration. For example, the passive damping windings 372 may be selectively switched to the short circuited configuration, thereby allowing the braking torque to be selectively produced and/or varied in magnitude.

FIG. 13 shows a sectional view of a fifth AFM assembly 370, according to the principles of the present disclosure. The fifth AFM assembly 370 may be similar or identical to the third AFM assembly 280, with the addition of a passive damping winding 372 within either or both of the first active PCB 264a and/or the second active PCB 264b. The passive damping winding 372 may have a short circuited configuration to produce a braking torque. In some embodiments, the passive damping winding 372 may be permanently connected in the short circuited configuration, thereby causing the passive damping winding 372 to produce a constant braking torque at all times. Alternatively or additionally, some or all of the passive damping windings 372 may be selectively connected in the short circuited configuration. For example, the passive damping windings 372 may be selectively switched to the short circuited configuration, thereby allowing the braking torque to be selectively produced and/or varied in magnitude.

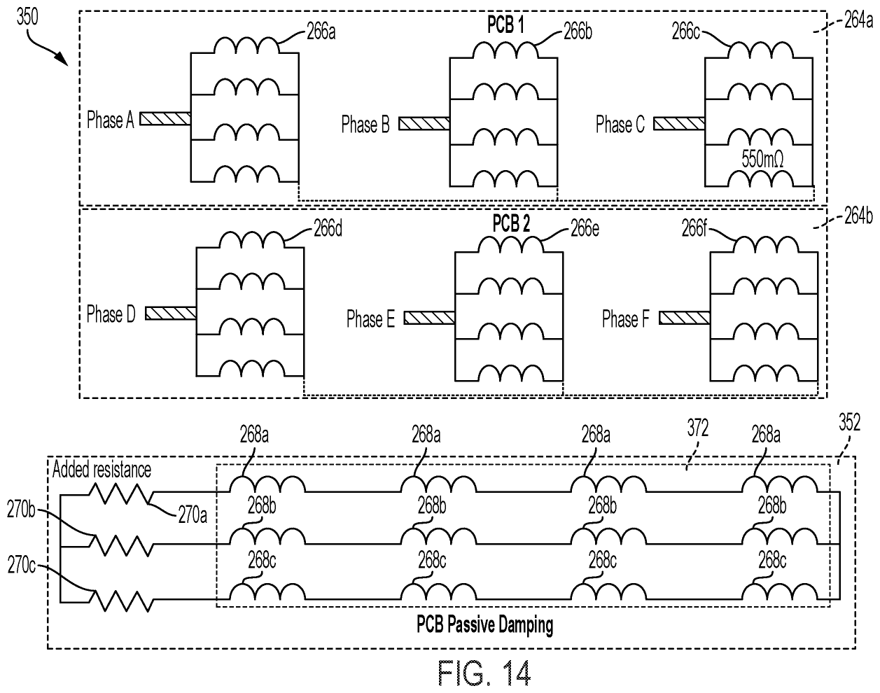

FIG. 14 shows an electrical schematic diagram of stator windings within the fourth AFM assembly 350. As shown, the fourth AFM assembly 350 includes the first active PCB 264a defining each of the A-phase stator windings 266a, the B-phase stator windings 266b, and the C-phase stator windings 266c. Each of the stator windings 266a, 266b, 266c includes four coils with a parallel configuration between a corresponding motor lead, labeled Phase A, Phase B, and Phase C, respectively, and a common neutral. The second active PCB 264b has a similar configuration, defining each of the D-phase stator windings 266d, the E-phase stator windings 266e, and the F-phase stator windings 266f. Thus, the stator windings 266a, 266b, 266c of the first active PCB 264a, and the stator windings 266d, 266e, 266f of the second active PCB 264b each have Wye connections. Alternatively, the stator windings may have a delta configuration. Each of the four coils that comprise each of the stator windings may have a resistance of 550 milliohm (550 m Ω). However, the coils may have different resistances, and the stator windings 266a, 266b, 266c may have a different number of constituent coils.

FIG. 14 also shows an electrical schematic diagram of the of the passive damping PCB 352, including passive damping coils 268a, 268b, 268c that comprise the passive damping windings 372. As shown, the passive damping windings 372 include four first passive damping coils 268a each connected in series and in series with a first added resistance 270a. The passive damping windings 372 also include four second passive damping coils 268b each connected in series and in series with a second added resistance 270b. The passive damping windings 372 also include four third passive damping coils 268c each connected in series and in series with a third added resistance 270c. However, any of the series combinations may have a different number of the passive damping coils 268a, 268b, 268c. Each of the series combinations of the passive damping coils 268a, 268b, 268c and the corresponding added resistances 270a, 270b, 270c are connected in parallel. The added resistances 270a, 270b, 270c are optional and may provide for additional braking torque to be generated and/or to limit the short circuit current generated in the passive damping windings 372, thus protecting the passive damping windings 372 from over-current conditions that can cause permanent damage, such as breakage of the passive damping windings 372

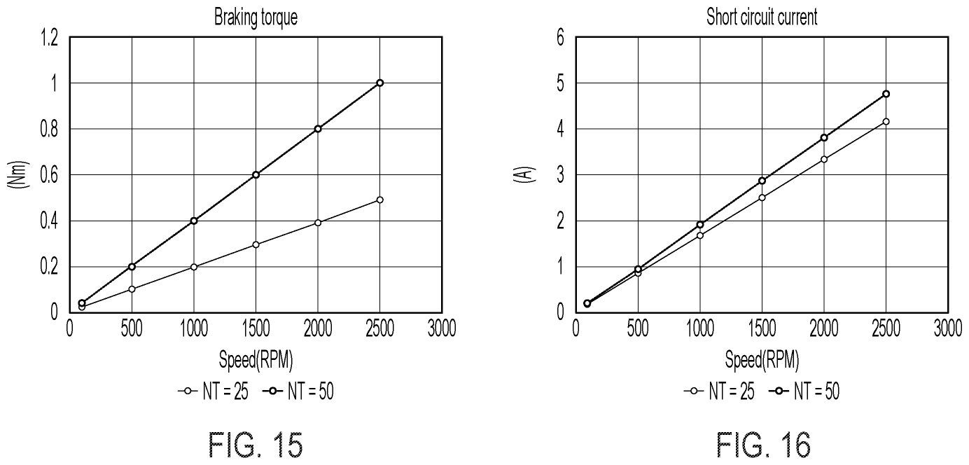

FIGS. 15-16 show graphs indicating braking torque and short circuit current, respectively, as a function of speed and for an AFM with passive damping windings 372 having twenty-five turns (NT=25) and fifty turns (NT=50). As shown, the braking torque and short circuit current each increase linearly with speed for each case, and the AFM with NT=25 produces two times the braking torque and only slightly more short circuit current than the AFM with NT=50.

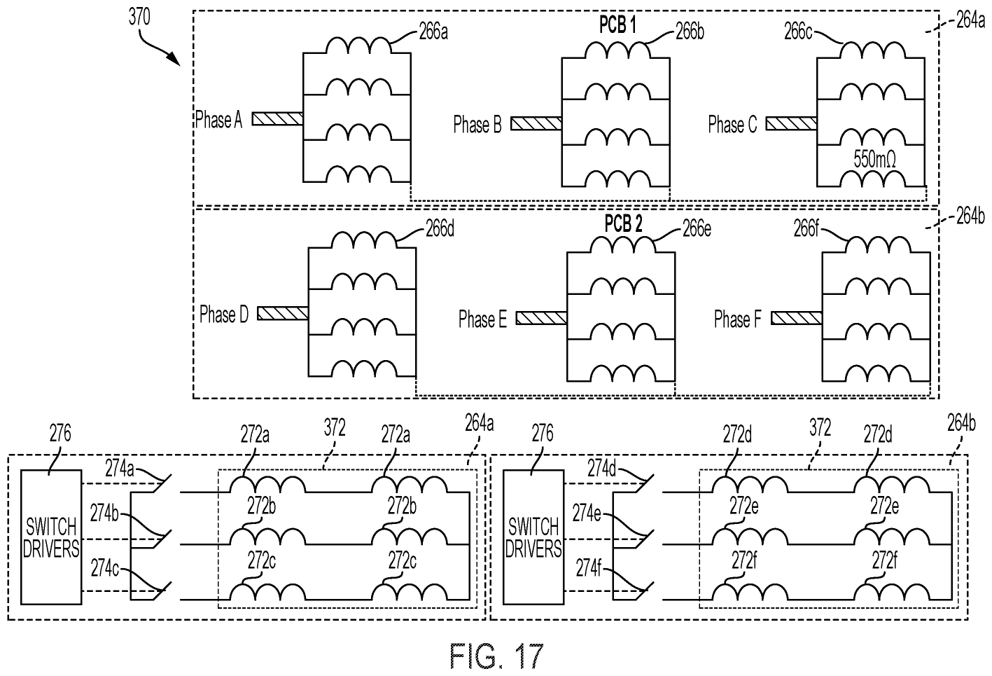

FIG. 17 shows an electrical schematic diagram of stator windings within the fifth AFM assembly 370. As shown, the fifth AFM assembly 370 includes the first active PCB 264a defining each of the A-phase stator windings 266a, the B-phase stator windings 266b, and the C-phase stator windings 266c. Each of the stator windings 266a, 266b, 266c includes four coils with a parallel configuration between a corresponding motor lead, labeled Phase A, Phase B, and Phase C, respectively, and a common neutral. The second active PCB 264b has a similar configuration, defining each of the D-phase stator windings 266d, the E-phase stator windings 266e, and the F-phase stator windings 266f. Thus, the stator windings 266a, 266b, 266c of the first active PCB 264a, and the stator windings 266d, 266e, 266f of the second active PCB 264b each have Wye connections. Alternatively, the stator windings may have a delta configuration. Each of the four coils that comprise each of the stator windings may have a resistance of 550 milliohm (550 m Ω. However, the coils may have different resistances, and the stator windings 266a, 266b, 266c may have a different number of constituent coils.

FIG. 17 also shows each of the first active PCB 264a and the second active PCB 264b defining one or more passive damping windings 372 operable in a short circuited configuration to produce a braking torque. As shown, the passive damping windings 372 of each of the first active PCB 264a and the second active PCB 264b include two first hybrid damping windings 272a connected in series with one another and with a first switch 274a configured to selectively conduct current through the first hybrid damping windings 272a to cause the first hybrid damping windings 272 to generate a braking torque. The passive damping windings 372 of each of the first active PCB 264a and the second active PCB 264b also includes two second hybrid damping windings 272b connected in series with one another and with a second switch 274b configured to selectively conduct current through the second hybrid damping windings 272b to cause the second hybrid damping windings 272b to generate an additional braking torque. The passive damping windings 372 of each of the first active PCB 264a and the second active PCB 264b also includes two third hybrid damping windings 272c connected in series with one another and with a third switch 274c configured to selectively conduct current through the third hybrid damping windings 272c to cause the third hybrid damping windings 272c to generate an additional braking torque. In some embodiments some or all of the hybrid damping windings 272a, 272b, 272c, may be connected to the motor leads in order to function as additional stator windings.

FIG. 17 also shows each of the first active PCB 264a and the second active PCB 264b including switch drivers 276 configured control operation of the switches 274a, 274b, 274c. Thus, each of the switches 274a, 274b, 274c and the switch drivers 276 may be disposed within or upon the first active PCB 264a and/or the second active PCB 264b. The switch drivers 276 may control individual operation of the switches 274a, 274b, 274c to produce varying amounts of braking torque.

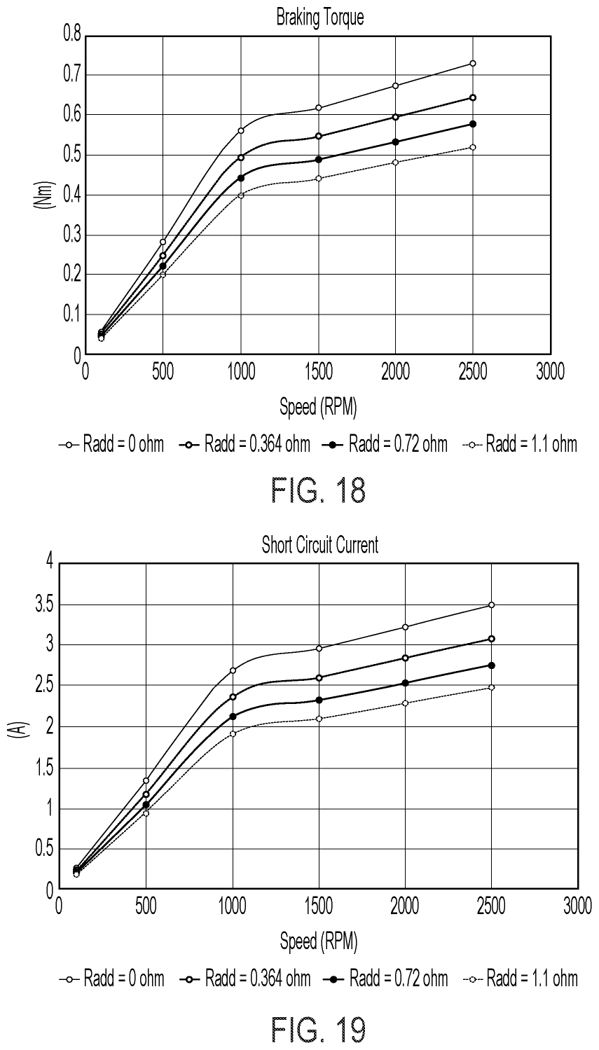

FIG. 18 shows a graph indicating braking torque as a function of speed for an AFM with short circuited windings different resistances. FIG. 19 shows a graph indicating short circuit current as a function of speed for an AFM with short circuited windings different resistances. FIGS. 18 and 19 each include plots for additional resistances Radd of 0 Ω, 0.364 Ω, 0.72Ω, and 1.1Ω. These different values additional resistances Radd may be determined based on a number and/or configuration of the hybrid damping windings 272a, 272b, 272c that are short circuited by the switches 274a, 274b, 274c. Therefore, the slope of the braking torque and the short circuit current can be changed based on a number of the hybrid damping windings 272a, 272b, 272c that are shortened.

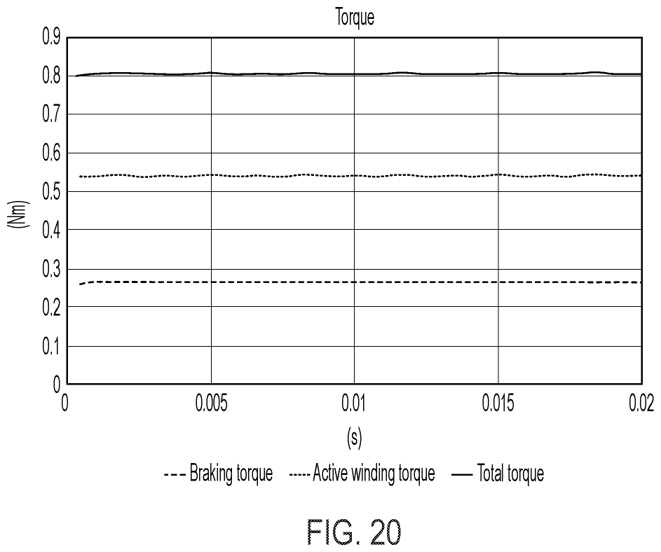

FIG. 20 shows a graph of torque over time, including plots representing braking torque, torque produced by active windings, and total torque, of an AFM with passive braking operated at 750 RPM. The graph of FIG. 20 shows second quadrant (Q2) operation, in which the total torque may be a sum of a braking torque produced by the passive damping coils 268a, 268b, 268c and/or the hybrid damping windings 272a, 272b, 272c, and active torque produced by the stator windings 266a, 266b, 266c of the active PCBs 264a, 264b.

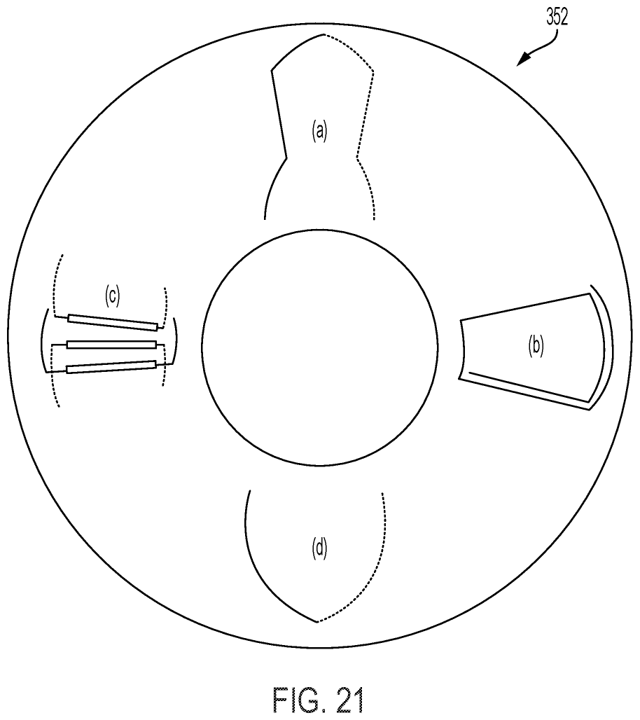

FIG. 21 shows the passive damping PCB 352 with a partial cut-away to show various different winding configurations for the passive damping PCB 352. The various different winding structures include: Lap winding (a), Concentric winding (b), Radial lap winding (c), and Arc winding (d). Similar or identical winding structures may be used in either or both of the active PCBs 264a, 264b. The passive damping windings may be connected differently than the active windings and in such a way to achieve a desired braking torque.

The present disclosure provides an axial flux machine (AFM). The AFM comprises: a rotor assembly configured to rotate about an axis and including a first rotor core and second rotor core, with each of the first rotor core and the second rotor core having a plurality of permanent magnets attached thereto, and with each of the first rotor core and the second rotor core spaced apart and parallel to one another and perpendicular to the axis; and a stator assembly including at least one PCB located between the first rotor core and the second rotor core and parallel thereto. The at least one PCB defines a stator winding configured to generate a magnetic flux in an axial direction through each of the first rotor core and the second rotor core to cause the AFM to generate a torque.

In some embodiments, the AFM further includes a motor shaft extending along the axis, and each of the first rotor core and the second rotor core is attached to the motor shaft to rotate therewith, and each of the first rotor core and the second rotor core is disposed circumferentially about the motor shaft.

In some embodiments, the at least one PCB includes a first PCB and a second PCB each extending parallel to one another and each located between the first rotor core and the second rotor core and parallel thereto.

In some embodiments, the stator winding includes a first set of active windings and a second set of active windings independent of the first set of active windings, with either of the first set of active windings or the second set of active windings being operable to generate the magnetic flux and to cause the rotor assembly to generate a torque.

In some embodiments, the at least one PCB includes a first PCB and a second PCB each extending parallel to one another and each located between the first rotor core and the second rotor core and parallel thereto; and the first PCB defines the first set of active windings and the second PCB defines the second set of active windings.

In some embodiments, the AFM further includes: a second rotor assembly configured to rotate about the axis and including a third rotor core and fourth rotor core, with each of the third rotor core and the fourth rotor core having a plurality of permanent magnets attached thereto, and with each of the third rotor core and fourth rotor core spaced apart and parallel to one another and perpendicular to the axis; and a second stator assembly including at least one second PCB located between the third rotor core and fourth rotor core and parallel thereto. In some embodiments, the at least one second PCB defines a second stator winding configured to generate a magnetic flux in an axial direction through each of the third rotor core and fourth rotor core to cause the AFM to generate a torque.

In some embodiments, the stator winding is one of a plurality of phase windings, and wherein the at least one PCB defines each of the plurality of phase windings.

In some embodiments, the at least one PCB further includes a passive damping winding having one or more short circuited configurations to produce a braking torque.

In some embodiments, the at least one PCB further includes a resistance connected to the passive damping winding.

In some embodiments, the at least one PCB includes: an active PCB defining the stator winding configured to generate the magnetic flux; and a passive damping PCB independent of the active PCB and defining the passive damping winding.

In some embodiments, the stator winding includes a first set of active windings and a second set of active windings independent of the first set of active windings, with either of the first set of active windings or the second set of active windings being operable to generate the magnetic flux and to cause the rotor assembly to generate a torque. In some embodiments, the at least one PCB includes a first PCB and a second PCB each extending parallel to one another and each located between the first rotor core and the second rotor core and parallel thereto, wherein the first PCB defines the first set of active windings and the second PCB defines the second set of active windings. In some embodiments, the AFM further includes a passive damping PCB defining the passive damping winding, the passive damping PCB disposed adjacent and parallel to each of first PCB and the second PCB.

In some embodiments, the AFM further includes a hybrid damping winding with a switch configured to selectively conduct current through the hybrid damping winding to cause the hybrid damping winding to generate a braking torque.

In some embodiments, the AFM further includes a switch driver configured to control operation of the switch, and wherein the hybrid damping winding, the switch, and the switch driver are each disposed within or upon the at least one PCB.

In some embodiments, the AFM further includes a plurality of hybrid damping windings and a plurality of switches, wherein each of the switches is configured to selectively conduct current through a corresponding one or more windings of the plurality of hybrid damping windings. In some embodiments, varying a configuration of the plurality of switches to conduct the current through the corresponding one or more windings causes the AFM to produce a varying amount of braking torque.

In some embodiments, the plurality of hybrid damping windings and the plurality of switches are each disposed within or upon the at least one PCB.

The present disclosure provides a steer-by-wire system for a vehicle. The steer-by-wire system includes a handwheel actuator coupled to apply a torque to a steering wheel. The handwheel actuator includes an axial flux machine (AFM). The AFM includes a rotor assembly configured to rotate about an axis. The rotor assembly includes a first rotor core and second rotor core, with each of the first rotor core and the second rotor core having a plurality of permanent magnets attached thereto, and with each of the first rotor core and the second rotor core spaced apart and parallel to one another and perpendicular to the axis. The AFM also includes a stator assembly. The stator assembly includes at least one PCB located between the first rotor core and the second rotor core and parallel thereto. The at least one PCB defines a stator winding configured to generate a magnetic flux in an axial direction through each of the first rotor core and the second rotor core to cause the AFM to generate a torque.

In some embodiments, the at least one PCB includes a first PCB and a second PCB each extending parallel to one another, and each located between the first rotor core and the second rotor core and parallel thereto.

In some embodiments, the stator winding includes a first set of active windings and a second set of active windings independent of the first set of active windings, with either of the first set of active windings or the second set of active windings being operable to generate the magnetic flux and to cause the rotor assembly to generate a torque.

In some embodiments, the at least one PCB further includes a passive damping winding having one or more short circuited configurations to produce a braking torque.

In some embodiments, the at least one PCB further includes a resistance connected to the passive damping winding.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. An axial flux machine (AFM) comprising:
a rotor assembly configured to rotate about an axis and including a first rotor core and second rotor core, with each of the first rotor core and the second rotor core having a plurality of permanent magnets attached thereto, and with each of the first rotor core and the second rotor core spaced apart and parallel to one another and perpendicular to the axis; and
a stator assembly including at least one PCB located between the first rotor core and the second rotor core and parallel thereto,
wherein the at least one PCB defines a stator winding configured to generate a magnetic flux in an axial direction through each of the first rotor core and the second rotor core to cause the AFM to generate a torque.

2. The AFM of claim 1, further comprising a motor shaft extending along the axis, wherein each of the first rotor core and the second rotor core is attached to the motor shaft to rotate therewith, and wherein each of the first rotor core and the second rotor core is disposed circumferentially about the motor shaft.

3. The AFM of claim 1, wherein the at least one PCB includes a first PCB and a second PCB each extending parallel to one another and each located between the first rotor core and the second rotor core and parallel thereto.

4. The AFM of claim 1, wherein the stator winding includes a first set of active windings and a second set of active windings independent of the first set of active windings, with either of the first set of active windings or the second set of active windings being operable to generate the magnetic flux and to cause the rotor assembly to generate a torque.

5. The AFM of claim 4, wherein the at least one PCB includes a first PCB and a second PCB each extending parallel to one another and each located between the first rotor core and the second rotor core and parallel thereto; and
wherein the first PCB defines the first set of active windings and the second PCB defines the second set of active windings.

6. The AFM of claim 1, further including:
a second rotor assembly configured to rotate about the axis and including a third rotor core and fourth rotor core, with each of the third rotor core and the fourth rotor core having a plurality of permanent magnets attached thereto, and with each of the third rotor core and fourth rotor core spaced apart and parallel to one another and perpendicular to the axis; and
a second stator assembly including at least one second PCB located between the third rotor core and fourth rotor core and parallel thereto,
wherein the at least one second PCB defines a second stator winding configured to generate a magnetic flux in an axial direction through each of the third rotor core and fourth rotor core to cause the AFM to generate a torque.

7. The AFM of claim 1, wherein the stator winding is one of a plurality of phase windings, and wherein the at least one PCB defines each of the plurality of phase windings.

8. The AFM of claim 1, wherein the at least one PCB further includes a passive damping winding having one or more short circuited configurations to produce a braking torque.

9. The AFM of claim 8, wherein the at least one PCB further includes a resistance connected to the passive damping winding.

10. The AFM of claim 8, wherein the at least one PCB includes: an active PCB defining the stator winding configured to generate the magnetic flux; and a passive damping PCB independent of the active PCB and defining the passive damping winding.

11. The AFM of claim 8, wherein the stator winding includes a first set of active windings and a second set of active windings independent of the first set of active windings, with either of the first set of active windings or the second set of active windings being operable to generate the magnetic flux and to cause the rotor assembly to generate a torque,
wherein the at least one PCB includes a first PCB and a second PCB each extending parallel to one another and each located between the first rotor core and the second rotor core and parallel thereto, wherein the first PCB defines the first set of active windings and the second PCB defines the second set of active windings, and
wherein the AFM further includes a passive damping PCB defining the passive damping winding, the passive damping PCB disposed adjacent and parallel to each of first PCB and the second PCB.

12. The AFM of claim 1, further comprising a hybrid damping winding with a switch configured to selectively conduct current through the hybrid damping winding to cause the hybrid damping winding to generate a braking torque.

13. The AFM of claim 12, further comprising a switch driver configured to control operation of the switch, and wherein the hybrid damping winding, the switch, and the switch driver are each disposed within or upon the at least one PCB.

14. The AFM of claim 1, further comprising a plurality of hybrid damping windings and a plurality of switches, wherein each of the switches is configured to selectively conduct current through a corresponding one or more windings of the plurality of hybrid damping windings, and
wherein varying a configuration of the plurality of switches to conduct the current through the corresponding one or more windings causes the AFM to produce a varying amount of braking torque.

15. The AFM of claim 14, wherein the plurality of hybrid damping windings and the plurality of switches are each disposed within or upon the at least one PCB.

16. A steer-by-wire system for a vehicle, comprising:
a handwheel actuator coupled to apply a torque to a steering wheel;
the handwheel actuator including an axial flux machine (AFM) including:
a rotor assembly configured to rotate about an axis and including a first rotor core and second rotor core, with each of the first rotor core and the second rotor core having a plurality of permanent magnets attached thereto, and with each of the first rotor core and the second rotor core spaced apart and parallel to one another and perpendicular to the axis; and
a stator assembly including at least one PCB located between the first rotor core and the second rotor core and parallel thereto,
wherein the at least one PCB defines a stator winding configured to generate a magnetic flux in an axial direction through each of the first rotor core and the second rotor core to cause the AFM to generate a torque.

17. The steer-by-wire system of claim 16, wherein the at least one PCB includes a first PCB and a second PCB each extending parallel to one another and each located between the first rotor core and the second rotor core and parallel thereto.

18. The steer-by-wire system of claim 16, wherein the stator winding includes a first set of active windings and a second set of active windings independent of the first set of active windings, with either of the first set of active windings or the second set of active windings being operable to generate the magnetic flux and to cause the rotor assembly to generate a torque.

19. The steer-by-wire system of claim 16, wherein the at least one PCB further includes a passive damping winding having one or more short circuited configurations to produce a braking torque.

20. The steer-by-wire system of claim 19, wherein the at least one PCB further includes a resistance connected to the passive damping winding.
